(19) United States
(12) Patent Application Publication
(10) Pub. No.: US 2010/0005318 A1
(43) Pub. Date: Jan. 7, 2010

(54) Process for securing data in a storage unit

(76) Inventor: Akram Hosain, Simi Valley, CA (US)

Correspondence Address: LOUIS L. DACHS, 1794 PALISADES DRIVE, PACIFIC PALISADES, CA, 90272, US

(21) Appl. No.: 12/217,200

(22) Filed: Jul. 2, 2008

(51) Int. Cl. H04L 9/32; H04L 9/06

(52) U.S. Cl. 713/193; 726/28

(57) ABSTRACT

The invention is a process for securing data in a storage unit using public and private key encryption and symmetrical encryption techniques by a owner of the data for use by multiple users. The process including the steps of: 1) encrypting the data; 2) attaching encrypted meta data to the encrypted data providing access at a selected level to the data by each of the multiple users, the access level to each of the multiple users being the ability to read and change the data, or the ability to only read the data, or no access to the data; 3) storing the encrypted data and meta data in the storage unit; and 4) providing each of the multiple users with de-encryption means such that the encrypted data can be de-encrypted at the selected level granted to each of the multiple users.

### BACKGROUND OF INVENTION

1. Field of Invention

The present invention relates to a process for securing data and in particular to a process for securing data in insecure mass memory storage.

2. Related Prior Art

Currently available systems do not provide a simple and complete secure file/record storage solution for an insecure mass memory, where the following fundamental quality can be seen: For example: U.S. Pat. Nos. 6,986,043 Encrypting File Systems and Method by Candieu, et al., 6,981,138 Encrypted Key Cashe by Douceiu, et al, and 6,249,866 Encryption File System And Method by Brundrell, et al. and Patent Publication Nos.: 20006130154 Method and System For Protecting And Verifying Stored Data by Wai Lam, et al., 20040175000 Method And Apparatus For Transaction-Based Secure Storage System by Garonni

These systems do not efficiently combine user authentication and encryption: in particular:

1. File/record is not provided with 100% protection from user and unauthorized modification to file data is not detected 100% of the time.
2. The existing systems do not provide good cryptographic file/record access control to support three file/record access modes; no-access, read only, and read-write.
3. They do not provide access control enforcement on a per file/record basis or for a group of similar files.
4. Most of the current insecure mass memory storage does not provide strong key management.
5. In existing systems and methods, user can not use existing key distribution and revocation due to its complexity.
6. Existing file/record protection mechanisms add extra burden on the file system.

Therefore it is a primary object of the invention to a process/method for file/record protection in insecure mass memory storage.

It is another object of the invention to provide for file/record protection in insecure mass memory storage wherein user authentication and encryption are provided.

It is another object of the invention to provide a process for file/record protection in insecure mass memory storage confidentiality, integrity, and non-repudiation quality for file/record data.

It is a further object of the invention to provide a process for file/record protection in insecure mass memory storage that supports for three file/record access modes; no-access, read only, and read-write.

It is a still further object of the invention to provide a process for file/record protection in insecure mass memory storage that eliminates the need for a user or group of users to keep any file keys for file/record system access.

It is a still further object of the invention to provide a process for file/record protection in insecure mass memory storage wherein a file key can be compatible with simultaneous use in other applications.

It is another object of the invention to provide a process for file/record protection in an insecure mass memory storage wherein the user does not have to have any knowledge of the file(s) encryption key(s).

It is another object of the invention to provide a process for file/record protection in insecure mass memory storage where in the user access revocation mechanism for the file system is simple and effective.

### SUMMARY OF INVENTION

The present invention provides a process for data protection in insecure mass memory storage (sometimes called data at rest). The process combines user authentication and encryption properly for user authentication. Confidentiality, integrity, and non-repudiation quality for file data are provided. The process supports three file/record access modes; no access, read only and read-write. Access control is supported on a per file/record basis or for a group of similar files. A user or a group of users will not be required to keep any keys for file system access. The key is compatible with simultaneous use in other applications. The user does not have to have any knowledge of the encryption key(s). The user access revocation mechanism for the file system is simple and effective. When read or write access to a file is revoked, the revoked user will immediately lose access to that file/record. Furthermore, the performance of the system is not hampered by providing these advantages.

In detail, the invention is a process/method for securing data in a storage unit using public and private key encryption and symmetrical encryption techniques by a owner of the data for use by multiple users, the process including the steps of: 1) encrypting the data; 2) attaching encrypted meta data to the encrypted data providing access at a selected level to the data by each of the multiple users, the access level to each of the multiple users being the ability to read and add/modify the data, or the ability to only read the data, or no access to the data; 3) storing the encrypted data and meta data in the storage unit; and 4) providing each of the multiple users with de-encryption means such that the encrypted data can be de-encrypted at the selected level granted to each of the multiple users at his/her level. A user can be a program process also.

The novel features which are believed to be characteristic of the invention, both as to its organization and method of operation, together with further objects and advantages thereof, will be better understood from the following description in connection with the accompanying drawings in which the presently preferred embodiment of the invention is illustrated by way of example. It is to be expressly understood, however, that the drawings are for purposes of illustration and description only and are not intended as a definition of the limits of the invention.

### BRIEF DESCRIPTION OF THE DRAWINGS

FIG. 1 is a representation of a fully redundant mass memory physical architecture with a cryptographic TOKEN plugged into a trusted control processor via a smartcard in a PCMCIA slot.

FIG. 2A is a representation of a data block structure.

FIG. 2B, is a representation of a file data structure.

FIG. 2C is a representation of a blocked hashed and signed file structure.

FIG. 3, is a representation of an access control of Meta data showing a logical structure for access control of a file.

FIG. 4 is a representation of file groups and user groups showing the grouping which provides efficiency for faster access.

FIG. 5, is a representation of key hierarchy showing the key encryption key and data encryption keys structure.

FIG. 6, is a representation of a reference monitor as part of the trusted control processor and which provides access control based on security label to provide read, or read/write access.

FIG. 7 is a flow chart of the control data generator used by the data owner.

FIGS. 8A and 8B is a flow chart of the data access process used by data users.

FIG. 9 is a flow chart of the reference monitor operation.

### DESCRIPTION OF THE PREFERRED EMBODIMENT

It is first necessary to define the following:

A) Symmetric keying uses one key to encrypt and to decrypt a block of text.
B) Public Key Infrastructure (PKI) uses two keys—mathematically related—one for encryption and another different key for decryption. One of key pair is called the public key and is made public, i.e., published, so all can obtain. The other of key pair is called the private key and is protected from loss or disclosure. When a datum is encrypted using the user's public key, only the user can access the plain text datum by decrypting the cipher text with his/her private key. That certifies for the public that only the designated user can read the datum. If the user encrypts the datum using his/her private key, anyone can read the datum by decrypting the cipher text with the user's public key that all can obtain. It certifies for the public that only the given user wrote the datum.
C) A Hash is a mathematical computation on a datum that produces a unique “hash” value. When the computation is repeated on the same datum the same hash results. For data transmitted over a communication line with the hash attached, the receiver can repeat the computation on the datum and obtain its hash. That computed hash is compared to the sent hash and the two hashes compared. They should be equal if the datum received is the same as the datum sent; no modification in transit. This same theory is being applied here for the data at rest.
D) A Signature attached to a datum provides a way to authenticate the datum. The Signature uses a user's name or ID encrypted in the sender's private key. The receiver checks the signature by decrypting it with the sender's public key. If it checks, it confirms the sender as the only one with the user's private key. If the sender hashes a datum and then signs the hash, the receiver can rehash the datum and decrypt the sent hash with the sender's public key. The two hashes will be equal if and only if the datum came from the sender and has not been modified in route. This same theory is being applied here for the data at rest.
E) The block cipher used is advanced encryption standard (AES) in Counter mode, the hash function is secure hash secure hash algorithm (SHA) and the signature scheme is elliptic curve digital signature algorithm (ECDSA). But other similar cryptography protocol/algorithms can be applied.

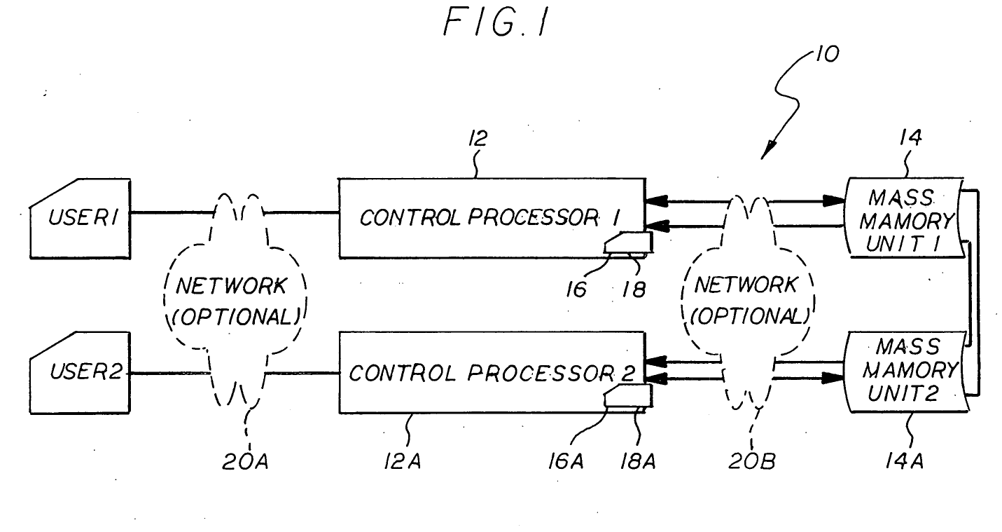

Referring initially to FIG. 1, which illustrates an example of the security boundary for the system generally indicated by numeral 10. Various components security boundaries are isolated by the separation kernel. A separation kernel is a type of security kernel used to simulate a distributed environment. The task of a separation kernel is to create an environment which is indistinguishable from that provided by a physically distributed system. It must appear as if each regime is a separate, isolated machine and that information can only flow from one machine to another along known external communication lines. Thus there are no channels for information flow between regimes other than those explicitly provided. Only one control processor will be sending messages to one mass memory unit (MMU) 14 at one time and vice-versa.

The MMU 14 could be RAM or RAID directly attached to control processor. A tamper proof token/smartcard 16 which stores the users' master key hosted in a PCMCIA slot 18 of the trusted control processor. The card will provide necessary crypto functions. The trusted control processor 16 handles all the key management, encryption, and all data file and Meta data construction via MMU native commands. In this manner all communication between the control processor 16 and the MMU 14 is cryptographically protected. Optional networks 20A and 20B may exist between the user and control processors 12 and between the control process 12 and MMU 14. The other control processor 16A, also having a token/smartcard 16A in PCMCIA slot 18A, coupled to a second MMU 14A could be incorporated for redundant backup purposes.

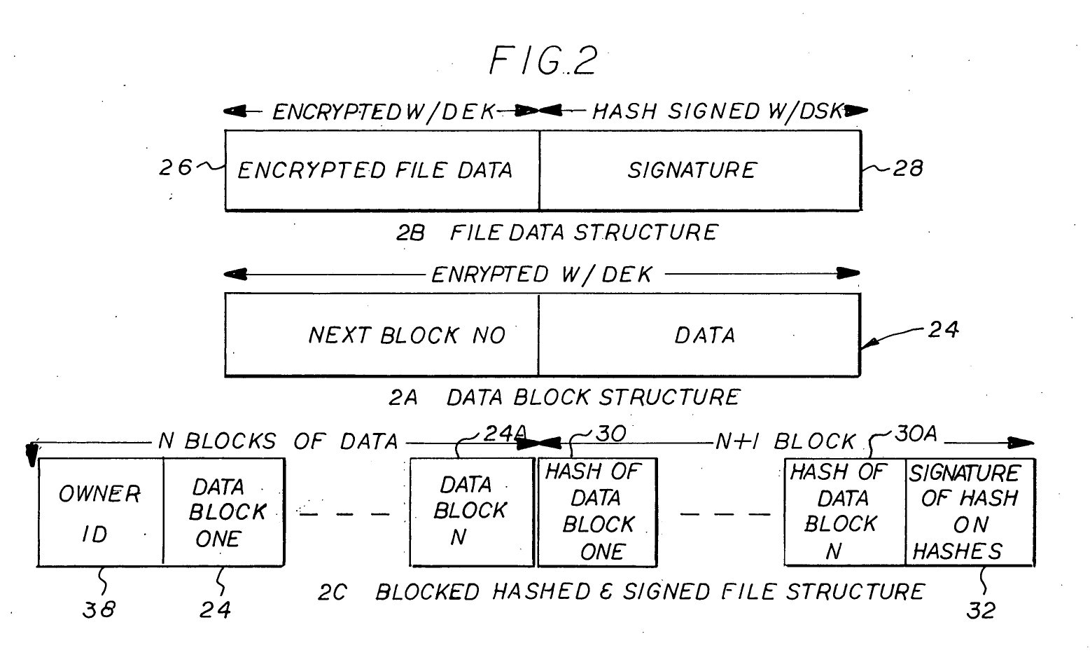

FIGS. 2A, 2B and 2C, illustrate typical file data contents and the file/record data format required for block 24 processing of a file. File data 26 is encrypted using the digital encryption key (DEKₛ) contained in the corresponding Meta data (Mata data other than file data, which will be subsequently discussed). A hash of the file data is computed and signed using the digital signature key (DK_{sig}) also contained in the Meta data. This signature 28 is appended to the end of the file.

A typical file consisting of data blocks one 24 (typically, 512 bytes per block) through data block N 24A matching the typical disc sectors containing the entire data file. Each block one 24 through N 24A are encrypted by the AES algorithm using Counter mode encryption. Counter mode permits encrypting a block separate from any other block. Next, a hash 30 through 30A is computed on each encrypted block one 24 through block N 24A. Finally, a hash 32 of all the block hashes is computed, and the hash-hash is signed with the private key of the user. Owner identification block 22 is added. With this information each subsequent user is permitted to use of the file/record using the public key of the file creator to check the hash-hash for the integrity of the file.

A data block, for example block one 24 within the file data is updated as follow. The Meta data has been verified and we have the DEK (DKₛ) (TODO) and DSK (DK_{sign}). SHA is used to Hash encrypted block one 24 and replace the hash 30 for block one 24 in the final hash block 32. SHA is reapplied to the concatenation of all block hashes to obtain a new file hash, i.e., hash of hashes, and sign that with the DSK (DK_{sign}).

For verification of a single file block, both the file block one 24 and the final hash block 32 are retrieved. File block 24 is rehashed and the file hash is re-computed using the hashes of all the other blocks. The actual file data blocks need not be retrieved. The signature from the hash block is re-verified i.e. corresponds to the computed file hash.

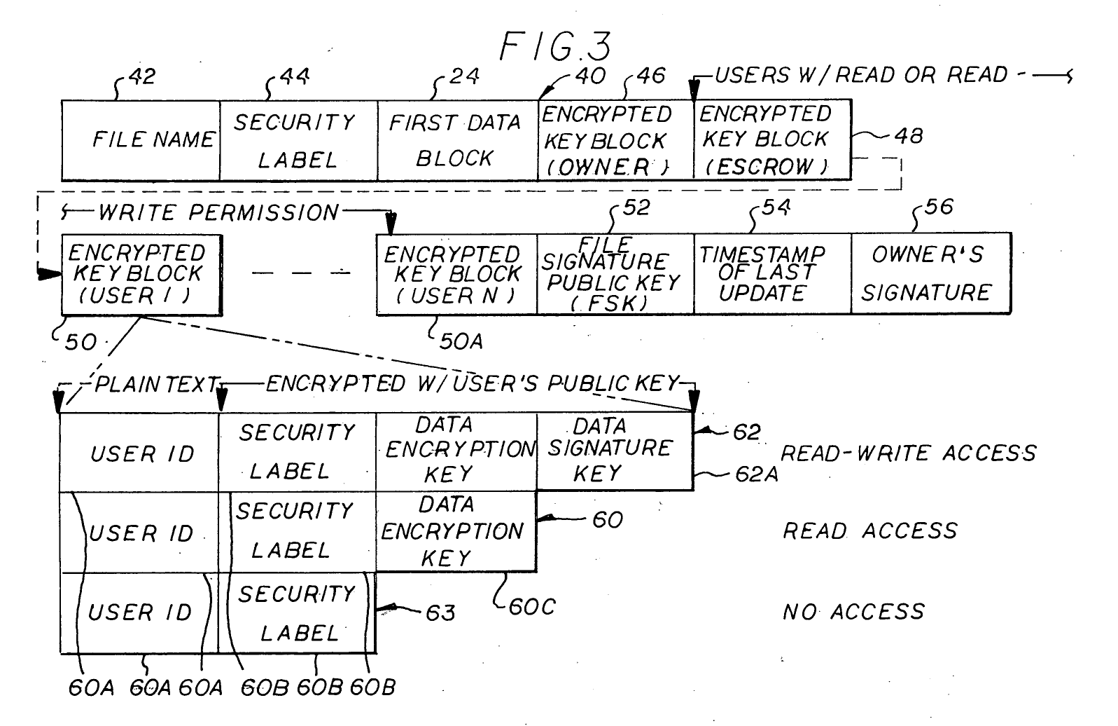

FIG. 3, the Meta data 40 contains access control information and its format is depicted. The meta data 40 includes the file name 42, security level 44, the data block, for example data block 24, owner encrypted key block 46, escrow encrypted key block 48 and encrypted key block for user one 50 to encrypted key block N 50A for user N. Each encrypted key block for user one 50 to user N 50A corresponds to a user (or a group of users) with some access rights to the corresponding file data. Also included in the Meta data 40 are the file signature key 52, time stamp 54 and owner's signature 56. Encrypted key blocks for user one 50 through user N 50A contain the file data encryption key (DEK) of each user with read access 60, which includes user ID 60A, security level (SL) 60B data encryption key 60C and data signature key 60D. Note that DKₛ, stands for symmetric key encrypted under the user public encryption key and Uk_{pub}, stands for user public key for encryption. If a user also has write access indicated by numeral 62, then the data signature key (DSK or DK_{sign} which stands for digital signature key) is included in the user's encrypted key block. If no read or right access is granted then access 63 is limited to user ID 60A and security level 60B. The Meta data also contains the public portion of the DSK (DK_{verify}, stands for sign verification key) i.e., FSK, un-encrypted so that readers can verify the integrity of the file data. The timestamp 54 is updated by the owner when the Meta data portion of the file is modified.

Of particular interest in this field is the Security Label (SL) 44 of the data file. The label is classification of file/record such as public, private, etc. SL 44 is used by the Reference Monitor (to be subsequently discussed) to permit cleared users security access to the data file/record. The Meta data part is signed by the file owners OSK (OK_{sign}, stands for signature key of the file owner) and hence can be updated only by the owner. Note that only the file owner has access to OK_{verify}, which stands for verification key of the file owner and can change the file SL. The first encrypted key block is always encrypted under the file owner's OEK (OK_{pub}, stands for public key of the owner). Furthermore, an escrow agency (A third party who wants to have access to the encrypted information, such as police, FBI, CIA, etc.) will have read access as the second block shows the encrypted key block for an escrow party.

The file owner generates an ECDSA Data Signing Key (DK_{sign}) and an AES Data Encryption Key (DKₛ). Owner's encrypted key block is formed by encrypting the (DK_{sign}) and (DKₛ) using owners OK_{pub} and tag the cipher text with the owner's user name. Apply SHA to the owner's encrypted key block, public key of the DK_{verify}, a timestamp, filename, and first block number. Sign the hash with ECDSA using the owner's Ok_{sign}. Create the Meta data by concatenating the owner's encrypted key block, public key of the DK_{verify}, the timestamp, the filename, the SL, and the signature OK_{sign}. Encrypt the file data with AES using the DKₛ. Apply SHA to the encrypted file data and sign the hash with ECDSA using the private key of the DK_{sign}. The cipher text is concentrated with the signature to create the file data.

Owner obtains the Meta data and verifies the signature with his/her OSK_{verify}. (Note that the owner has the public key of users, since she or he created all user keys.) If the user is only granted read access, owner encrypts only the DKₛ using user's public key UK_{pub}. For user's write access, owner encrypts both the DKₛ and DK_{sign}. The cipher text, together with user's user name is the encrypted key block to be added to the Meta data. Owner adds a user's encrypted key block to the Meta data and updates the timestamp to the current time. S/he applies SHA to the modified Meta data and signs the hash using ECDSA with his/her Ok_{sign}. One replaces the signature on the Meta data. Owner replaces the old Meta data with the new version. Note, the data file SL is set once by the owner at the time of the Meta data and file creation. All users must have clearances that dominate the file SL or access is denied by the Reference Monitor.

User obtains the Meta data and identifies the file owner by extracting the user name tag from the first encrypted key block. User obtains the owner's OK_{verify} from user smartcard (via cert) or the system already has that in a PKI such as LDAP and verifies the signature on the Meta data part of the file. Then user locates the encrypted key block with his/her user name in the Meta data and decrypts the key block to obtain the DKₛ and/or DK_{sign}. The user obtains the file data, and verifies the signature using the public key of the DK_{sign}; encrypts the file data with the DKₛ. Add user identity to the file data, i.e., “Joe” at the last block. Hash of the encrypted file data (current block+last block) and signs the hash with the DK_{sign}. The signature is appended to the newly generated cipher text to create the new file data.

User obtains the Meta data information and identifies the file owner by extracting the user name tag from the first encrypted key block. Obtains the owner's OK_{pub} from user smartcard or it is already in the trusted system and verifies the signature on the Meta data. User locates the encrypted key block with the reader's user name in the Meta data, and decrypts the key block to obtain the DKₛ obtains the file data and verifies the signature using the public key of the DK_{verify}; decrypts the encrypted file data with the DKₛ to obtain the file contents.

The owner generates a new DKₛ for read access revocation. Using this key, the file data is updated by encrypting the file data with the new key and then signs using the old DKₛ. The revoked user's encrypted key block is removed from the Meta data and all the remaining key blocks are updated with the new DKₛ. Finally, the Meta data is signed with the owner's OK_{sign}.

Write access revocation is the same as read access revocation except that a new DK_{sign} is also generated. The encrypted key blocks are updated with this new DK_{sign} and the file data is signed with this new key. Revoking write access also involves creating a new DKₛ and re-encrypting the file data because write access implicitly provides read access.

All users maintain one “master” key, their PKI private key, for asymmetric decryption—KEK, (UKₚᵣᵥ, stands for user private key). Each block of file data is encrypted using a block cipher (i.e. AES) in Counter mode and each block is also hashed i.e., SHA-384 (SHA-384 produces 384 bits hash) for integrity. A hash tree construction will be used to relate block integrity to file integrity. As mentioned earlier, the Meta data part contains the access control information, while the file data part contains the encrypted and signed contents. The file data is encrypted with a symmetric cipher using a unique key—data encryption key DKₛ for each file or a group of similar files. The file data is also signed using a signature scheme with a unique key—data signature key DK_{sign} for that file or a group of similar files.

The DKₛ and DK_{sign} are used to differentiate between read and write access. Possession of only the DKₛ gives read only access to the file while possession of both the DKₛ and DK_{sign} allows read and write access. For example, a user with only the DKₛ cannot create a valid file because s/he cannot produce a valid file signature.

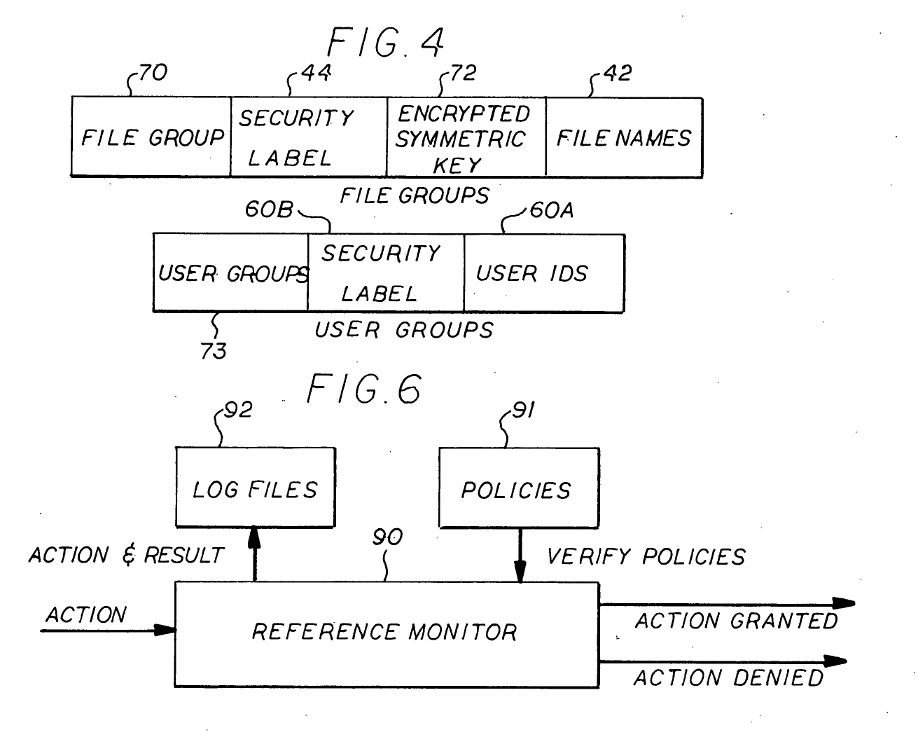

FIG. 4, shows how files/records and users can be grouped. Similar types of files can be grouped 70 together and the same symmetric key 72 can be used to encrypt and decrypt that set of files. This helps to reduce the number of keys needs to be managed. Further, files groups, symmetric keys, and file names 42 can be cached in a volatile memory for faster and efficient access.

User groups 73 can support producers-subscribers access models, where users can be grouped together based on role, coalition, and/or security label. This helps faster and efficient access control, since access is based on group, instead of individual. In this invention, we have said that the information is in the mass memory storage, but the information such as user groups, users, and access control can be cached in other types of memory such as volatile memory for faster and efficient processing.

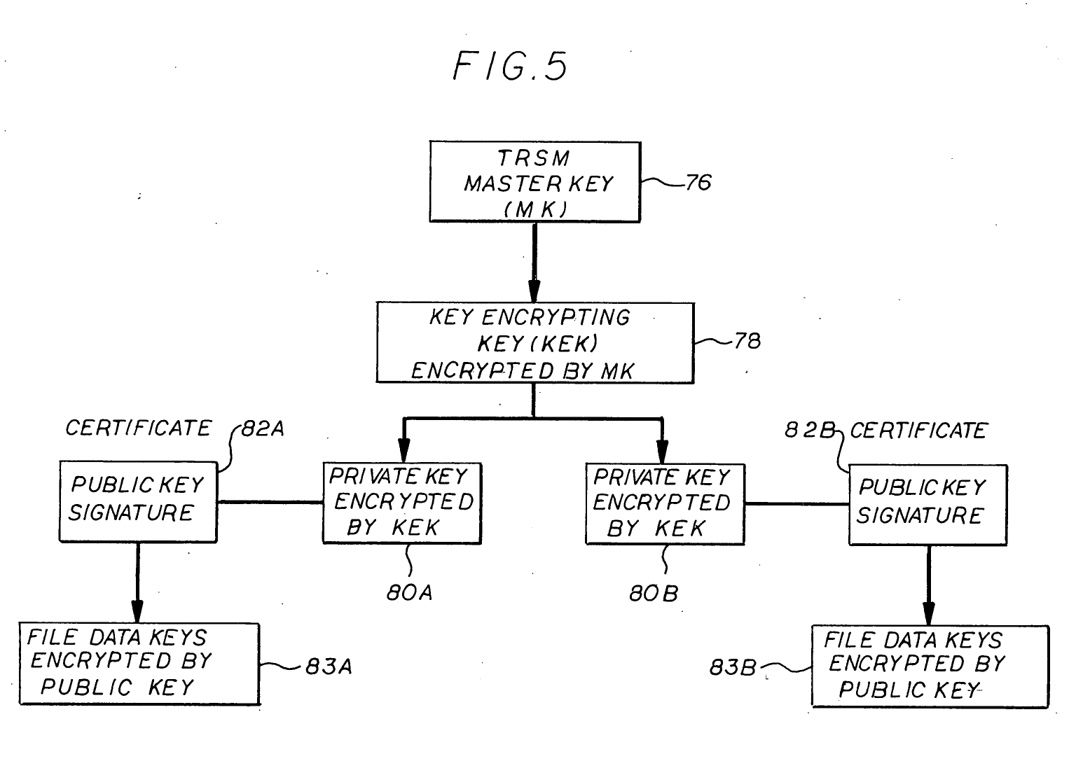

FIG. 5, shows an example of a hybrid key architecture. Private and public keys may be deployed within a fixed hybrid key hierarchy, for instance with the following keys:

1. Master key 76 is stored inside TRSM (Tamper Resistance Security Module), typically a symmetric key.
2. Key-encrypting key 78 (KEK)—optional. Typically, a symmetric key—encrypted by the master key.
3. Private keys 80A and 80B are encrypted with corresponding public keys 82A and 82B. The private keys are encrypted by the master key or a key-encrypting key when outside the TRSM.
4. Public keys 82A and 82B corresponding to the private keys 80A and 80B —authenticity may be protected with a certificate created by a Certification Authority signature.
5. Data Encryption Key 83A and 83B; user data is encrypted by Data Encryption Key and the “Data Encryption Key” is further encrypted by “User Public Key”

The Key Hierarchy for each user of all users of the file system is a protected data structure in the trusted Control Processor of the system. It is contained in the TOKEN in this description. However, it may be stored and managed as part of the Trusted Computing Base (TCB) of the Control Processor. PIN-protected, tamper-resistant hardware (i.e., smartcard in PCMCIA slot) provides high level of security to master keys (i.e. private keys). Storing master keys encrypted with password also provides additional protection. Binding the authentication session between the user and token also prevents an attacker from profitably stealing a token, and then later a mass memory device. Binding between the token and the Control Processor further enhances security of the system.

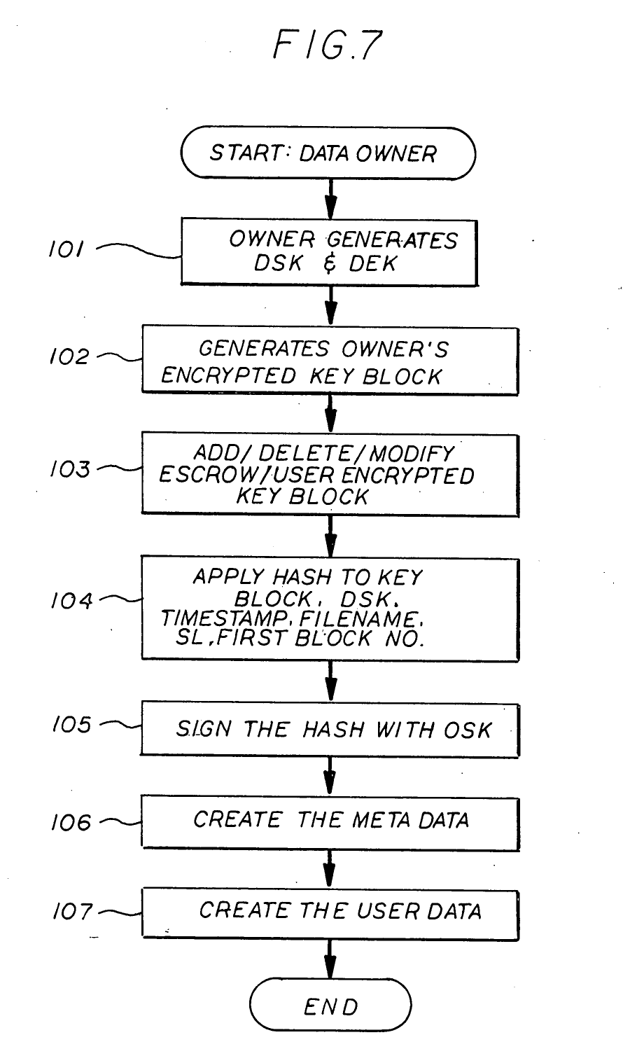

Still referring to FIGS. 1-5 and additionally to FIG. 6, the reference monitor (RM) 90 is the heart of the secure access control in the trusted Control Computer. A user makes a file access request to read or write a file. The RM 90 retrieves the SL 44 from the Meta data of the corresponding file and compares it to the SL 44 of the user found in the RM trusted user group private information. If the user SL 44 dominates the file SL 44, access is permitted. Dominance means the SL 44 of the user is greater than or equals that of the file SL 44, and the file compartments are a subset of the user compartments. After satisfying the security access the user is allowed to Read or Read/Write the file to the extent of his/her permission in the Meta data.

The RM 90 input actions are user file references and output decisions are Booleans, i.e., yes or no access permitted. Actions are basically file commands supported by the MMU 14A and 14B component (FIG. 1). When a user or a process wants to execute a command, the Reference Monitor based on polices 91 decides whether the command should be executed or not. The decisions are based on the policies, which can be set by the administrator(s), and the credentials of the user or process who/which execute the command, i.e., the SL 44 Dominance relation. The RM audits its actions in the Log Files 92.

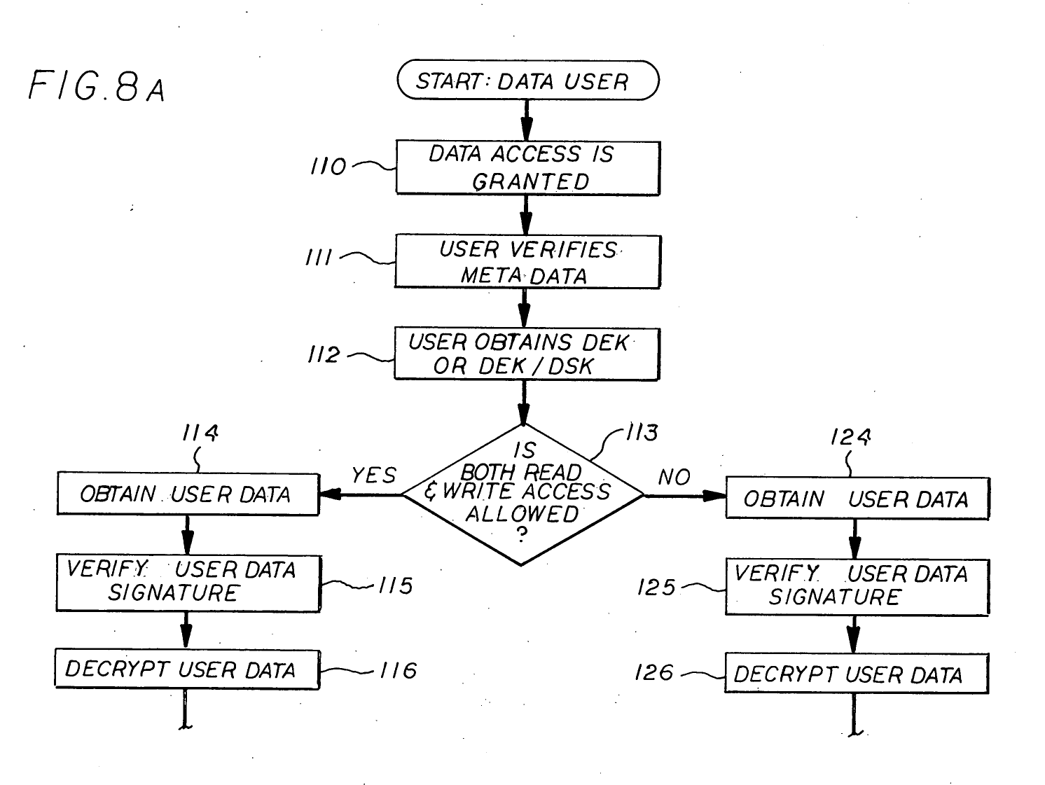

Referring to the flow chart of FIG. 7, the overall process is as follows:

Step 101—Owner generates DEK and DSK encryption codes.
Step 102 Owner generates encryption key block.
Step 103 Owner creates, adds to or modifies escrow and users key block
Step 104 Owner applies hash to data block, DSK. timestamp, filename, SL, and first file block.
Step 105 Owner signs hash with OSK
Step 106 Owner creates Mata data
Step 107 Owner creates the user data

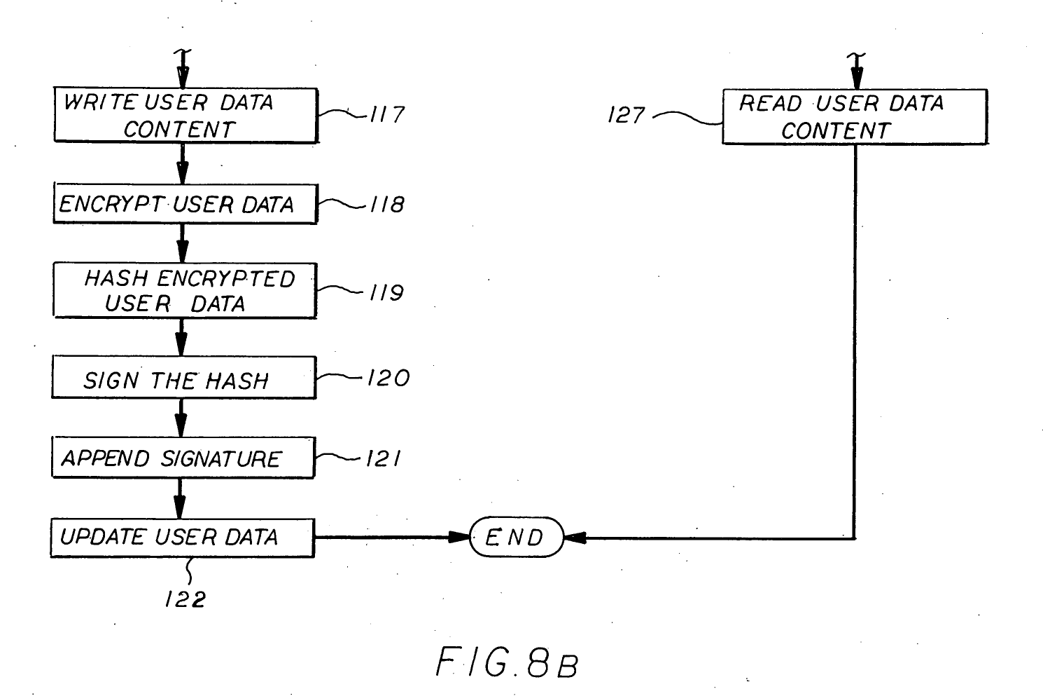

Referring to the flow chart of FIGS. 8A and 8B the flow chart of the data user is as follows:

Step 110 Data access Granted
Step 111 User verifies Meta data
Step 112 User obtains DEK and DEK/OSK
Step 113 Determine if user has both read and write access
If Yes, then:
Step 114 Obtains user data
Step 115 Verify user data signature
Step 116 Decrypts data
Step 118 Write user data block(s)
Step 119 Encrypt user data
Step 120 Hash encrypted user data
Step 121 Sign hash
Step 122 Append signature
Step 123 Update user data

If No, then

Step 124 Obtain data file
Step 125 Verify user data signature
Step 126 Decrypt user data
Step 127 Read user data

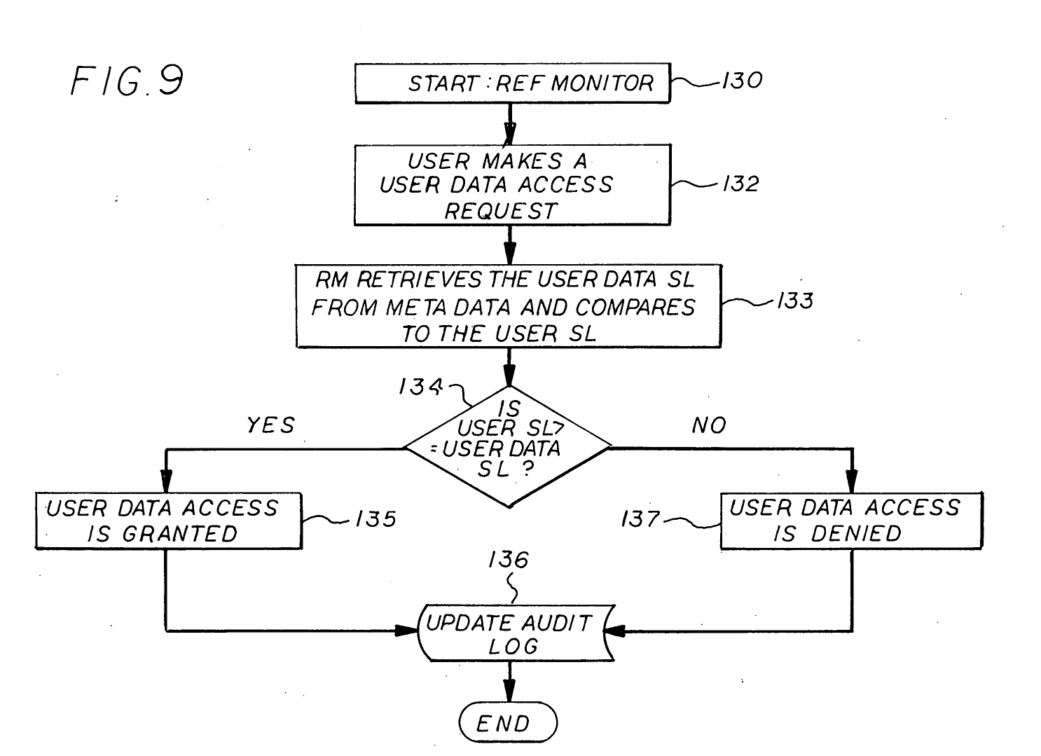

Referring to FIG. 9, the reference monitor flow chart is as follows

Step 130 Start reference monitor
Step 132 User makes a user access request
Step 133 Reference Monitor retrieves the user data SL for the Meta data and Compares to user SL
Step 134 Determine if SL is user data SL
If yes, then
Step 135 User data access is granted
Step 136 Update audit log
If no, then
Step 137 user access denied
Step 136 Update audit log

Thus it can be seen that the present invention provides a process for file/record protection of data in an insecure mass memory storage. User authentication and encryption properly for user authentication is provided. Confidentiality, integrity, and non-repudiation quality for file data are provided. Three access modes are provided: no access, read only and read-write. Access control is supported on a per file basis or for a group of similar files. A user or a group of users will not be required to keep any keys for file system access. The key is compatible with simultaneous use in other applications. The user does not have to have any knowledge of the encryption key(s). The user access revocation mechanism for the file system is simple and effective. When read or write access to a file is revoked, the revoked user will immediately lose access to that file. Furthermore, the performance of the system is not hampered by providing these advantages

While the invention has been described with reference to a particular embodiment, it should be understood that the embodiment is merely illustrative as there are numerous variations and modifications which may be made by those skilled in the art. Thus, the invention is to be construed as being limited only by the spirit and scope of the appended claims.

### INDUSTRIAL APPLICABILITY

The invention has applicability to the computer software industry, in particular to those involved in information security.

1. A process for securing data in a storage unit of a computer system using public and private key encryption and symmetrical encryption techniques by a owner of the data for use by multiple users, the process including the steps of:
encrypting the data;
attaching encrypted meta data to the encrypted data providing access at a selected level to the data by each of the multiple users, the access level to each of the multiple users being the ability to read and add/modify the data, or the ability to only read the data, or no access to the data;
storing the encrypted data and Meta data in the storage unit; and
providing each of the multiple users with de-encryption means such that the encrypted data can be de-encrypted at the selected level granted to each of the multiple users.

2. The process as set froth in claim 1 wherein the data is encrypted with a symmetric code and the symmetric code is encrypted with the public key.

3. The process as set forth in claim 2 wherein the computer system includes a reference monitor with an audit log coupled thereto; the process including the steps of:
retrieving the user data security level for the meta data and compares it to user security level and determines if they are equal by means of the reference monitor; and
granting access if the user if the security level of the user is acceptable and refusing access to the security level is unacceptable; and
updating the audit log.

4. The process as set forth in claim 3 including the steps of:
owner obtains DEK and DSK encryption codes;
owner generates encryption key block;
owner creates, adds to or modifies escrow and users key block;
owner applies hash to data block, DSK. Timestamp, filename, security level and first file block;
owner signs hash with OSK;
owner creates Mata data; and
owner creates the user data.

5. The process as set forth in claim 4, including the steps of:
data user obtains access;
data user verifies Meta data;
data user obtains DEK and DEK/OSK;
if data user has both read and write access:
data user obtains user data;
data user verifies user data signature
data user decrypts data
data user modifies data content;
data user encrypts modified data content;
data user encrypts user modified data;
data user creates hash encrypted user modified data content
data user signs hash of encrypted user modified data content; and
data user appends signature.

6. The process as set forth in claim 5, including the steps of:
data user obtains access;
data user verifies Meta data;
data user obtains DEK and DEK/OSK; and
if data user has only read access to data
user verifies user data signature; and
user decrypts user data.

7. A process for securing data in a storage unit of a computer system using public and private key encryption and symmetrical encryption techniques by a owner of the data for use by multiple users, the process including the steps of:
encrypting the data;
encrypting meta data providing access at a selected level to the data by each of the multiple users, the access level to each of the multiple users being the ability to read and add/modify the data, or the ability to only read the data, or no access to the data;
attaching the encrypted meta data to the encrypted data;
storing the encrypted data and Meta data in the storage unit; and
providing each of the multiple users with de-encryption means such that the encrypted data can be de-encrypted at the selected level granted to each of the multiple users.

8. The process as set froth in claim 7 wherein the data is encrypted with a symmetric code and the symmetric code is encrypted with the public key.

9. The process as set forth in claim 8 wherein the computer system includes a reference monitor with an audit log coupled thereto; the process including the steps of:
retrieving the user data security level for the meta data and compares it to user security level and determines if they are equal by means of the reference monitor; and
granting access if the user if the security level of the user is acceptable and refusing access to the security level is unacceptable; and
updating the audit log.

10. The process as set forth in claim 9 including the steps of:
owner obtains DEK and DSK encryption codes;
owner generates encryption key block;
owner creates, adds to or modifies escrow and users key block;
owner applies hash to data block, DSK. Timestamp, filename, security level and first file block;
owner signs hash with OSK;
owner creates Mata data; and
owner creates the user data.

11. The process as set forth in claim 10, including the steps of:
data user obtains access;
data user verifies Meta data;
data user obtains DEK and DEK/OSK;
if data user has both read and write access:
data user obtains user data;
data user verifies user data signature
data user decrypts data
data user modifies data content;
data user encrypts modified data content;
data user encrypts user modified data;
data user creates hash encrypted user modified data content
data user signs hash of encrypted user modified data content; and
data user appends signature.

12. The process as set forth in claim 11 including the steps of:
if data user has only read access to data
user verifies user data signature; and
user decrypts user data.
